(19) United States
(12) Patent Application Publication
(10) Pub. No.: US 2026/0133150 A1
(43) Pub. Date: May 14, 2026

(54) METHOD AND APPARATUS FOR BOMB CALORIMETRY

(71) Applicant: Solid Power Operating, Inc., Louisville, CO (US)

(72) Inventors: Omar Anthony Chaarawi, Boulder, CO (US); Saalik Rauf, Louisville, CO (US)

(21) Appl. No.: 19/385,841

(22) Filed: Nov. 11, 2025

Related U.S. Application Data
(60) Provisional application No. 63/718,887, filed on Nov. 11, 2024.

(51) Int. Cl. G01N 25/44

(52) U.S. Cl. CPC G01N 25/44

(57) ABSTRACT

A method comprises positioning a sample within an interior volume of a sealable vessel, positioning a first electrode adjacent to the sample such that a first gap is formed between the sample and the first electrode, positioning a second electrode within the interior volume, sealing the sealable vessel, and positioning the sealable vessel within a bomb calorimeter. The method further includes causing an energy to flow between the first electrode and second electrode to cause a reaction in the sample, measuring at least one temperature change within the bomb calorimeter induced by the reaction in the sample, and determining a change in enthalpy via the measured at least one temperature change.

### CROSS-REFERENCE TO RELATED APPLICATIONS

This application claims the benefit of and priority to U.S. Application No. 63/718,887, filed Nov. 11, 2024. The entire disclosure of the above application is incorporated herein by reference.

### TECHNICAL FIELD

Aspects of the disclosure relate to bomb calorimetry, and more particularly to mechanisms used in bomb calorimetry analysis of battery components.

### BACKGROUND

With the ever-increasing adoption of mobile devices, electric automobiles, and the development of Internet-of-Things devices, the need for battery technologies with improved reliability, capacity (Ah), thermal characteristics, lifetime, and recharge performance has never been greater. While some battery technologies offer potential increases in safety, packaging efficiency, and enable new high-energy chemistries, further improvements are needed.

In one example, battery thermal runaway is a phenomenon that can occur when internal heating causes heat-generating reactions within the battery, leading to self-sustaining reactivity that can cause the battery to catch fire or explode. The initial heating event may be caused by unforeseeable reactions within the cell, by common abuse conditions (e.g., short circuit testing), or by external heat. Once a sufficient internal temperature is reached, a domino-like effect occurs where unwanted side reactions continually produce more heat, thereby triggering additional nearby reactions. In battery packs, the rise in temperature can also affect nearby batteries, causing the entire battery system to catch fire.

Traditional bomb calorimetry ignition mechanisms initiate reactions using a resistive heater via the joule heating method. A current passed through a wire produces heat that initiates the reaction or combustion of a material in a sealable, thermally isolated vessel often charged with oxygen. The change in temperature induced by the reaction is used to determine the energy produced by the reaction or samples. The consumable resistive heater contributes to the thermal mass and reaction enthalpy. Additionally, the heating of the wire is inexact and contributes energy (˜100 Joules), which may decrease the accuracy of the measurement. In some cases, this joule heating method does not effectively ignite battery materials as one or more of the components of the cell are conductive, causing a short circuit to the cell material or the concentration of the heat is insufficient.

### OVERVIEW

In accordance with an aspect of the present disclosure, a method for determining change in enthalpy includes positioning a sample within an interior volume of a sealable vessel, positioning a first electrode adjacent to the sample such that a first gap is formed between the sample and the first electrode, positioning a second electrode within the interior volume, sealing the sealable vessel, and positioning the sealable vessel within a bomb calorimeter. The method further includes causing an energy to flow between the first electrode and second electrode to cause a reaction in the sample, measuring at least one temperature change within the bomb calorimeter induced by the reaction in the sample, and determining a change in enthalpy via the measured at least one temperature change.

In accordance with another aspect of the present disclosure, an apparatus includes a first sealable chamber, a second sealable chamber configured to be positioned within the first sealable chamber, a pair of electrodes, a voltage power source, and a controller. The controller is configured to control the power source to cause an energy to flow between the pair of electrodes positioned within the second sealable chamber to cause a reaction in a sample positioned adjacent to a first electrode of the pair of electrodes, collect temperature measurement data during the reaction in the sample, and determine an enthalpy based on the temperature measurement data, wherein the energy caused to flow between the pair of electrodes generates an arc across a gap separating the first electrode from the sample.

In accordance with another aspect of the present disclosure, a method for causing a reaction in a sample includes positioning the sample within a bomb of a bomb calorimeter, positioning a first electrode of an igniter adjacent to the sample, spacing the first electrode from the sample such that a first gap is formed between the sample and the first electrode, and positioning a second electrode adjacent to the sample such that the sample is one of spaced from the sample by a second gap and electrically coupled with the sample. The method further includes sealing the bomb, sealing the bomb within the bomb calorimeter, controlling a voltage power source coupled with the first and second electrodes to cause an energy to flow between the first electrode and second electrode to cause a reaction in the sample, and determining an enthalpy change resulting from a reaction of the sample to the flow of the energy.

### BRIEF DESCRIPTION OF THE DRAWINGS

The drawings illustrate examples presently contemplated for conducting the invention.

In the drawings:

FIG. 1 is a block diagram of a bomb calorimeter according to one or more aspects of this disclosure.

FIGS. 2-4 illustrate block diagrams showing a reaction facilitator according to one or more aspects of this disclosure.

FIG. 5 is a flowchart showing a method for measuring enthalpy of a sample according to one or more aspects of this disclosure.

While the present disclosure is susceptible to various modifications and alternative forms, specific examples thereof have been shown by way of example in the drawings and are herein described in detail. It should be understood, however, that the description herein of specific examples is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Examples are provided so that this disclosure will be thorough and will fully convey the scope to those who are skilled in the art. Numerous specific details are set forth such as examples of specific components, devices, and methods, to provide a thorough understanding of examples of the present disclosure. It will be apparent to those skilled in the art that specific details need not be employed, that examples may be embodied in many different forms and that neither should be construed to limit the scope of the disclosure. In some examples, well-known processes, well-known device structures, and well-known technologies are not described in detail.

Although the disclosure hereof is detailed and exact to enable those skilled in the art to practice the invention, the physical examples herein disclosed merely exemplify the invention which may be embodied in other specific structures. While the preferred example has been described, the details may be changed without departing from the invention, which is defined by the claims.

Aspects of this disclosure relate to bomb calorimetry. Bomb calorimetry is a technique that may be used to measure the energy released by a substance. The substance may be sealed in an airtight container called a bomb, which is usually submerged in water. Although described as being airtight, in this example the gas within the vessel is not required to be air. The words airtight and “hermetically sealed” are used interchangeably herein. Thus, as it is used herein, “airtight” is not limited to usage of air within the bomb. Further, examples herein may refer to the substance as a sample or a specimen. Such terminology is non-restrictive to the type or origin of the object or the relation of object to another object. Thus, “sample” and “specimen” may be used interchangeably herein.

In one example, one or more electrodes are positioned adjacent to the sample to cause it to react. Such reactions may include burning, combustion, oxidation, evaporation, melting, reduction, and the like. In some examples, the reactions cause a phase change to happen to some or all of the sample. In response to the reaction(s) of the sample, the energy released changes the temperature of the vessel and surrounding water, and this temperature change is used to calculate the change in heat by reaction.

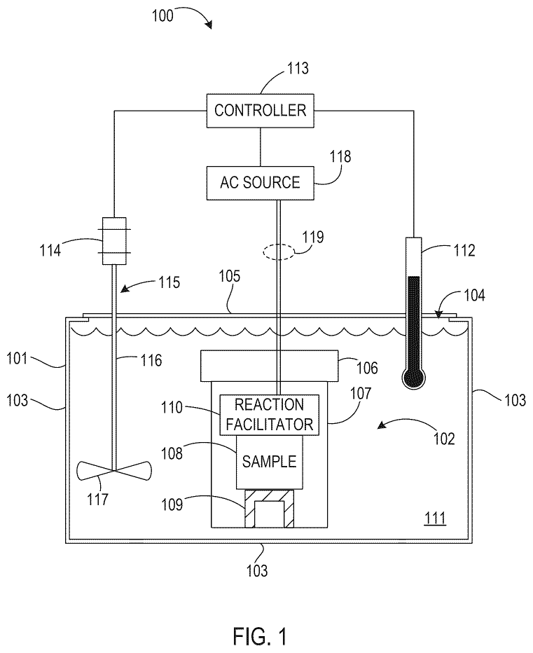

FIG. 1 illustrates a block diagram of a bomb calorimeter 100 according to one or more aspects of this disclosure. The bomb calorimeter 100 includes chamber 101 into which a sealable vessel 102 may be placed. The chamber 101 can have a plurality of walls 103 with an opening 104 formed to allow the sealable vessel 102 to be placed inside the chamber 101. A chamber lid 105 allows the interior volume of the chamber 101 to be thermally insulated. The sealable vessel 102, which may also be referred to as a bomb or a pressure vessel, includes a lid 106 and a vessel body 107. The vessel body 107 is hermetically sealable by the lid 106.

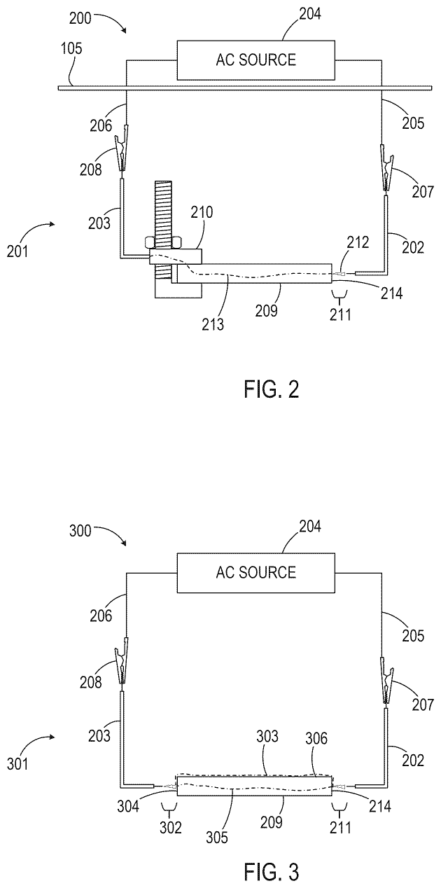

A sample or specimen 108 is placed inside the vessel body 107 on a support 109, and a reaction facilitator 110 is attached to or positioned adjacent to the sample 108. For example, various examples of placing the reaction facilitator 110 in contacting or non-contacting arrangements with the sample 108 are discussed herein with respect to FIGS. 2-4. The reaction facilitator 110 is intended to cause the sample 108 to react as described herein such as, for example, combustion, burning, and other reactions. Thus, for some types of samples, the reaction facilitator 110 may be an igniter configured to cause a combustion or burning reaction in the sample.

In the bomb calorimeter 100, an interior volume 111 is configured to be filled with a liquid such as water, and a temperature of the liquid is measured by a measuring device 112 such as a thermometer and used by a controller 113 to determine temperature changes in the liquid during the process to determine an enthalpy of the reacting sample 108. The liquid may be stirred by a stirring motor 114 controlling a stirrer 115 having a stirring shaft 116 and stirring blades 117 to mix the liquid to evenly distribute the liquid temperature throughout the liquid.

According to examples herein, the reaction facilitator 110 is controlled or energized by a power source 118 configured to generate a high voltage AC current through a wired connection 119 to the reaction facilitator 110. In one example, the reaction facilitator 110 includes one or more electrodes (see FIGS. 2-4) configured to cause the sample 108 to begin its reaction(s).

FIG. 2 illustrates a block diagram showing an example arrangement 200 for causing or generating a reaction in a sample. A reaction facilitator 201 can include a plasma igniter system having a pair of electrodes 202, 203 coupled with a high-voltage AC source 204 (e.g., 118 of FIG. 1) by a pair of lead wires 205, 206 that may pass through the chamber lid 105 of the chamber 101 of FIG. 1. In examples, the lead wires 205, 206 may pass through a wall 103 of the chamber 101 or the pair of electrodes 202, 203 may pass through the chamber lid 105 or a wall 103 of the chamber 101. As shown, the lead wires 206, 205 are coupled with the electrodes 203, 202 using clips 207, 208 such as alligator clips. However, other electrically conductive methods of coupling the lead wires 206, 205 to the electrodes 203, 202 are contemplated herein such as soldering, clamping, twisting, and the like. Further, the electrodes 203, 202 may be replaced in response to having a sufficient amount of their material consumed over many uses.

In one example, the reaction facilitator 201 is a high voltage plasma device (or arc device) used to initiate a chemical reaction in a sample 209 such as by thermal runaway of an electrochemical cell components or samples. A fastener 210 is electrically coupled with the electrode 203 and with the sample 209 (e.g., sample 108 of FIG. 1). A clamp as shown or another type of temporary fastener such as an alligator clip may be used. The electrode 202 is positioned adjacent to a surface of the sample 209 such that a gap 211 is formed between the electrode 202 and the sample 209. The electrode 202 is not directly coupled with the sample when no energy is provided between the electrodes 202, 203. However, the sample may be electrically conductive and couplable with the electrode 202 via an electrical arc in which energy is transferred between the electrode 202 and the sample 209 by electrical conduction across the gap 211 through ionization of the gas contained in the vessel. In one example, the sample is formed of a material like one or more of the materials found in a battery cell. For example, the sample 209 could be one or more of a cathode active material, anode active material, solid electrolyte material, binder, or carbon additive. The sample may be in the form of a cathode layer comprising a cathode active material, an anode layer comprising an anode active material, or a separator layer comprising a solid electrolyte material. The cathode layer, anode layer, or separator layer may further comprise a current collector or carrier foil where the current collector or carrier foil may comprise one or more of a metal such as nickel, copper, aluminum, lithium, or a polymer or polymer composite.

In another embodiment, the sample may be a multilayer stack comprising one or more anode layer, cathode layer, or separator layer. In some configurations of the multilayer stack, the anode layer and/or the cathode layer is in physical contact with the separator layer.

In further embodiments, other types of electrically conductive materials for non-battery uses may also be induced to react using this disclosure. In response to a voltage provided by the controller 204, arcing 212 across or through the gap 211 initiates the reaction in the sample 209. For example, causing the sample to combust. The high voltage plasma device operates to induce a reaction in the sample 209 via arcing across a gap (e.g., 211).

FIG. 2 further shows examples of energy or current flow from the electrode 202 to the electrode 203 (or vice versa) that may be experienced by the sample 209. Some samples are best addressed from a narrow edge. Accordingly, the electrode 202 may be positioned as illustrated in FIG. 2. A first current flow 213 (shown in phantom) flows through the sample 209 from a shortest or near shortest distance between the edge 214 of the sample 209 and the electrode 202 across the gap 211. A current flow through the sample 209 in this manner can cause the sample 209 to experience an input of heat sufficient to initiate reaction.

FIG. 3 illustrates a block diagram showing another example arrangement 300 for causing or generating a reaction in a sample. The arrangement 300 modifies the reaction facilitator 201 shown in FIG. 2. As shown in the arrangement 300, a reaction facilitator 301 includes the electrode 203 separated from the sample 209 by a second gap 302. The gaps 201, 302 may be of a similar length; however, the distance between the electrode 203 and the sample 209 may be different than the distance between the electrode 202 and the sample 209.

Similar to FIG. 2, FIG. 3 shows examples of current flow from the electrode 202 to the electrode 203 (or vice versa) that may be experienced by the sample 209. In a first example, a current flow 303 crosses the gap 211 and flows through an interior of the sample 209. At the second edge 304 of the sample 209, the current flow 303 crosses the gap 302 toward the electrode 203. In a second example, a current flow 305 crosses the gap 211 and flows along the surface 306 of the sample 209. The current flow 305 crosses the gap 302 toward the electrode 203.

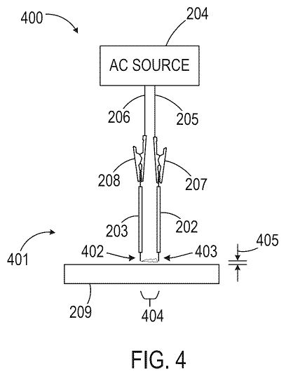

FIG. 4 illustrates a block diagram showing another example arrangement 400 for causing or generating a reaction in a sample. The arrangement 400 modifies the reaction facilitators 201, 301 shown in FIGS. 2 and 3. As shown in the arrangement 400, a reaction facilitator 401 includes the ends 402, 403 of the electrodes 203, 202 being separated by a gap 404 from each other sufficient to cause sparking or arcing therebetween. The ends 402, 403 are also positioned adjacent to the surface 306 of the sample 209 such that a gap 405 between the arcing and the surface 306 of the sample 209 is designed to induce the target reaction in the sample 209.

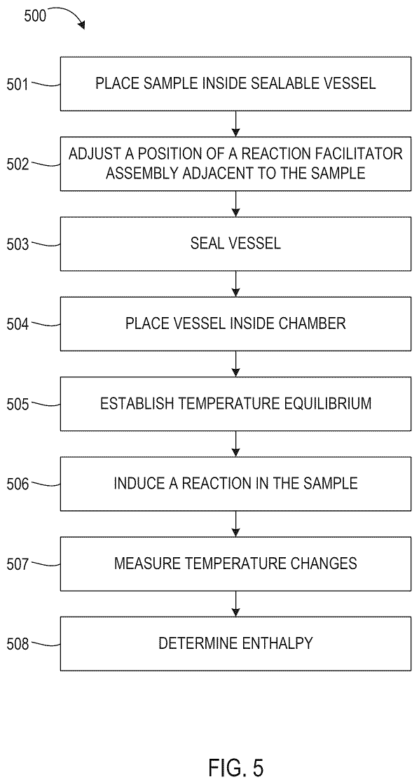

FIG. 5 is a flowchart showing a method 500 for measuring enthalpy of a sample according to one or more aspects of this disclosure. The method 500 begins at step 501 by placing a sample (e.g., the sample 108) inside a vessel body 107. A reaction facilitator is coupled with a high voltage AC source by arranging a pair of electrodes adjacent to the sample at step 502. While both electrodes may be separated from the sample by a gap, in some arrangements, one of the electrodes may be electrically coupled with the sample prior to activation of the voltage source. However, at least one electrode is separated from the sample by a respective gap in all arrangements. The vessel is hermetically sealed at step 503 to prevent matter from escaping the interior of the vessel. The vessel may contain a gas of choice at a certain pressure of choice. It is not required in this disclosure that the gas contains oxygen. For example, the interior volume of the sealable vessel 102 when sealed may have an inert atmosphere or an anaerobic atmosphere comprising nitrogen, hydrogen, or a noble gas such as argon. The sealable vessel 102 may be placed inside a bomb calorimeter chamber (e.g., chamber 101) at step 504, and a liquid may be placed within the chamber if the bomb calorimeter 100 of FIG. 1 is used.

To calculate a temperature change from the beginning of the reaction process to the end, an initial or baseline temperature is established at step 505 such that the chamber and the vessel are at a temperature equilibrium. The sample is induced to react at step 506, and temperature change during reaction of the sample is measured at step 507 using temperature sensors (e.g., measuring device 112). At step 508, the change in enthalpy of the reacted sample is determined.

Examples of this disclosure allow for remote ignition or other reaction of samples in inert atmosphere with less additional energy than the more conventional fuse-wire method. The examples of this disclosure offer an improvement over the fuse wire method because shorts to the cell components are avoided that prevent the initiation of the reaction. By using a high voltage arc, higher temperatures may be achieved locally than with a wire fuse. A hotter, more precise trigger mechanism induces cell component runaway reaction. Examples herein offer a more concentrated application of heat and achieve higher temperatures with less power input than with prior art methods. Furthermore, the lighting mechanism (e.g., igniter) is reusable as it is not consumed during the enthalpy experiment. The sample may also be a material that, by itself, is not or is minimally electrically conductive. The sample may be used in its pure form in one example. In another example, the sample may be mixed with an electrically conductive material such as carbon and pressed into a pellet or other compressed form. The pellet may then be used in the examples described herein. For example, a current passing through a first electrode (e.g., 202) at a voltage high enough for an arc to form and contact either the sample or the second electrode (e.g., 203). The testing may be conducted in an atmosphere that may be ionized (e.g., able to carry electrons) but is also oxygen free.

While the invention has been described in detail in connection with only a limited number of examples, it should be readily understood that the invention is not limited to such disclosed examples. Rather, the invention may be modified to incorporate any number of variations, alterations, substitutions, or equivalent arrangements not heretofore described, but which are commensurate with the spirit and scope of the present disclosure. Additionally, while numerous examples of the present disclosure have been described, it is to be understood that aspects of the present disclosure may include only some of the described examples. Accordingly, the invention is not to be seen as limited by the foregoing description but is only limited by the scope of the appended claims.

What is claimed is:

1. A method for determining change in enthalpy comprising:
positioning a sample within an interior volume of a sealable vessel;
positioning a first electrode adjacent to the sample such that a first gap is formed between the sample and the first electrode;
positioning a second electrode within the interior volume;
sealing the sealable vessel;
positioning the sealable vessel within a bomb calorimeter;
causing an energy to flow between the first electrode and second electrode to cause a reaction in the sample;
measuring at least one temperature change within the bomb calorimeter induced by the reaction in the sample; and
determining a change in enthalpy via the measured at least one temperature change.

2. The method of claim 1, wherein an electrical arc is formed across the first gap between the first electrode and the sample in response to causing the energy to flow.

3. The method of claim 2 further comprising:
coupling a first wire to the first electrode;
coupling a second wire to the second electrode; and
coupling the first and second wires to an AC energy source.

4. The method of claim 3, wherein the first and second wires pass through a lid of the bomb calorimeter.

5. The method of claim 1, wherein the sample comprises a cathode material suitable for a battery cell.

6. The method of claim 1, wherein the sealable vessel comprises a bomb.

7. The method of claim 1, wherein positioning the second electrode comprises electrically coupling the second electrode with the sample.

8. The method of claim 1, wherein positioning the second electrode comprises positioning a second electrode adjacent to the sample such that a second gap is formed between the sample and the second electrode.

9. The method of claim 1, wherein positioning the second electrode comprises positioning the second electrode adjacent to the first electrode such that a second gap is formed between the first and second electrodes; and
wherein the first gap defines a distance between an end of the first electrode and a surface of the sample.

10. The method of claim 1 further comprising an atmosphere within the sealable vessel to be one of an inert atmosphere and an anaerobic atmosphere.

11. An apparatus comprising:
a first sealable chamber;
a second sealable chamber configured to be positioned within the first sealable chamber;
a pair of electrodes;
a voltage power source; and
a controller configured to:
control the power source to cause an energy to flow between the pair of electrodes positioned within the second sealable chamber to cause a reaction in a sample positioned adjacent to a first electrode of the pair of electrodes;
collect temperature measurement data during the reaction in the sample; and
determine an enthalpy based on the temperature measurement data;
wherein the energy caused to flow between the pair of electrodes generates an arc across a gap separating the first electrode from the sample.

12. The apparatus of claim 11, further comprising a fastener configured to electrically couple a second electrode of the pair of electrodes with the sample.

13. The apparatus of claim 11, wherein the voltage power source comprises an AC power source.

14. The apparatus of claim 11, wherein the first sealable chamber comprises a bomb calorimeter.

15. The apparatus of claim 11, wherein the second sealable chamber comprises a bomb.

16. A method for causing a reaction in a sample comprising:
positioning the sample within a bomb of a bomb calorimeter;
positioning a first electrode of an igniter adjacent to the sample;
spacing the first electrode from the sample such that a first gap is formed between the sample and the first electrode;
positioning a second electrode adjacent to the sample such that the sample is one of spaced from the sample by a second gap and electrically coupled with the sample;
sealing the bomb;
sealing the bomb within the bomb calorimeter;
controlling a voltage power source coupled with the first and second electrodes to cause an energy to flow between the first electrode and second electrode to cause a reaction in the sample; and
determining an enthalpy change resulting from a reaction of the sample to the flow of the energy.

17. The method of claim 16 further comprising:
spacing the second electrode from the sample by the second gap; and
in controlling the voltage power source to cause the energy to flow:
causing a first arc to extend between the first electrode and the sample; and
causing a second arc to extend between the second electrode and the sample.

18. The method of claim 16 further comprising:
directly electrically coupling the second electrode with the sample; and
in controlling the voltage power source to cause the energy to flow:
causing a first arc to extend between the first electrode and the sample; and
causing the energy to be exchanged between the second electrode and the sample via conductive energy transfer.

19. The method of claim 16, wherein the reaction of the sample comprises a combustion of at least a part of the sample induced by the energy caused to flow between the first electrode and second electrode.

20. The method of claim 16 further comprising submerging the bomb in water positioned with the bomb calorimeter.
